(19) United States
(12) Patent Application Publication
(10) Pub. No.: US 2006/0085235 A1
(43) Pub. Date: Apr. 20, 2006

(54) Inventory mitigation and balancing system for dynamically and iteratively tracking, matching, and exchanging inventory excess and storage

(76) Inventors: Huy Nguyen, Cupertino, CA (US); Perpetua B. Tranlong, Cupertino, CA (US)

Correspondence Address: HUY NGUYEN, 21702 LINDY LANE, CUPERTINO, CA, 95014, US

(21) Appl. No.: 11/201,043

(22) Filed: Aug. 10, 2005

Related U.S. Application Data
(60) Provisional application No. 60/602,619, filed on Aug. 19, 2004.

(51) Int. Cl. G06F 9/44; G06F 17/50

(52) U.S. Cl. 705/7; 705/28

(57) ABSTRACT

A computer-implemented inventory management system is provided in which inventory data and inventory balancing transactions are conducted external to existing inventory databases by means of automated and computerized system permitting the participation of multiple users and warehouse locations to track, search, match and complete inventory mitigation and balancing transactions. More particularly, the invention relates to an inventory managements system which can be operated in conjunction with and parallel to existing enterprise resource planning software, and within which data, transaction, communication and information can be updated dynamically and iteratively in responses to changes or as a result of prior balancing transactions, and within which data views and executable functions are presented to each user uniquely based on the user's uniquely-identified criteria, and within which transaction data are tracked, stored and maintained dynamically and iteratively.

### CROSS-REFERENCE TO RELATED APPLICATION

This application claims the benefit of prior U.S. Provisional Application Ser. No. 60/602,619 filed Aug. 19, 2004, which is hereby incorporated by reference.

### STATEMENT REGARDING FEDERALLY SPONSORED RESEARCH OR DEVELOPMENT

Not applicable.

### FIELD OF THE INVENTION

The present invention relates generally to inventory management with automated inventory mitigation and balancing solution. More particularly, it pertains to automated and computerized methods and system creating an inventory depository and tracking to track, search, match and complete inventory mitigation and balancing transactions.

### BACKGROUND ART

In business, inventory control is a major issue facing large and small corporations. Insufficient inventory of raw materials or parts during the crucial production process, i.e, inventory shortage, means lost sales and lost opportunities. Excess inventory, on the other hand, can lead to significant increase in storage costs, overhead costs, parts obsolescence, and lost liquidity. The patterns of inventory excess and shortage typically cost companies and the economy millions, sometimes billions of dollars.

Today, numerous software tools, products and systems exist in the field of supply chain management (SCM) to attempt to curb the patterns of inventory excess and shortage. But the reality of SCM differs dramatically from its promise, and the continuing inventory snafu is propelling the continuing need to evolve and innovate.

The reasons existing systems and software have not fulfilled the needs of users are numerous and include the following principal reasons:
The typical supply chain for which the majority of SCM solutions were developed has evolved from an internally-owned function with a small number of players to a widely dispersed supply chain with far-flung geographical reach and largely-outsourced functions, with hundreds or even thousands of participants across the globe. Communication and compatibility across this new complex structure remain a challenge to be solved.
Many markets, including markets for electronic products and computer products, now have significantly shortened product lifecycles. For example, the expected life of a high tech product is now as short as nine to twelve months. User demand for faster, more powerful technologies has shortened product lifecycles dramatically, decreasing manufacturers' opportunity to make profits on new products and accelerating greatly the planning and production cycles. It is a major challenge for SCM systems to keep up with the ever-changing planning and production cycle.
Manufacturers are increasingly turning to contract manufacturers (CMs) and outsourced solution providers as faster, more cost-effective channels for procuring parts and producing products. The result of this outsourcing has been the creation of broad virtual manufacturing networks that span the globe, bringing with them new and ever-complex barriers to productivity, including communication barriers, logistic barriers, planning barriers among others.

To solve these problems, various SCM systems exist which focus ever more on supply chain control, the speed and collection of inventory information, the delivery of inventory information, and ultimately the control of inventory planning and stocking.

In contrast, electronic means of inventory mitigation and balancing are rudimentary and uncoordinated. More typically, inventory mitigation is handled through a network of independent brokers or off-price discounters outside of the enterprise network, with little understanding or linkage into the business process. Inventory mitigation is often handled locally by local management at each warehouse. Although management may try to obtain the best recovery possible for excess inventory, the local and piecemeal approach to inventory mitigation often means that excess inventory is sold off for pennies on the dollar.

On the other hand, shortage in inventory presents a significant production problem which must be resolved. Unless the manufacturing location knows of an excess supply of parts of inventory elsewhere within the enterprise, and also is aware of the right contact and procedures to move the needed parts and inventory to the manufacturing location, new parts and inventory would have to be purchased or ordered, driving up manufacturing costs for the entire enterprise.

Within any major business enterprise, excess inventory at one local could often be transferred to meet shortage at another location within the same enterprise if locatable and if procedures are in place for the inventory mitigation and balancing. Currently, there are no electronic comprehensive means coupled with the existing prior art inventory resource planning software to track excess and shortage in real time and empower the users with real time tools to identify, negotiate and complete advantageous inventory balance, exchanges and mitigation.

A system-wide understanding of all the inventory and parts available across the enterprise is further advantageous in designing and quick manufacturing of products. In many current manufacturing environments, multiple products (for example mobile cell phones) share the same basic platforms and parts, with many minor styling differences and feature differences for different local markets and tastes. If a manufacturing team for a local market can easily access and evaluate the excess parts and functionalities of cell phones in different market, they can easily incorporate these existing parts and functionalities into their own products through an inventory balancing transaction within the enterprise at a significantly reduced cost to the enterprise in sourcing new parts and designs.

It will be appreciated by one skilled in the art that there are significant limitations to the current hodge podge of tools, products and systems in mitigating and balancing inventory excess and shortages, some of which are detailed above.

### SUMMARY AND DETAILED DESCRIPTION OF THE INVENTION

The present invention in its several disclosed embodiments combine best of breed in supply chain and inventory management systems with an innovative inventory mitigation system dependent on user-initiated exchange and trading of excess and shortage inventory across the single business enterprise or, optionally, across a plurality of business enterprise and its business partners including contract manufacturers and third party service providers.

An object of the present invention is to provide a method and system that allows for the deployment of the inventory mitigation and balancing business solution ideally suited for a web hosting environment or a web exchange environment or for the use of a business enterprise providing inventory balancing and mitigation service among its network of CM, suppliers, internal departments and external outsourced solutions provider where the network participants may have very different business logic, data sources, inventory system and inventory mitigation system.

A further object of the present invention is to provide a method and system to maximize user-initiated transactions without the necessity for users to compile or code software programs or even to understand software logic.

Still another object of the present invention is to provide a method and system which can dynamically and iterative update and populate throughout the system inventory balance, changes in business solutions of various users, and other data and business solutions within the system.

Yet another object of the present invention is that the users can have functionalities and features similar to those currently provided by existing SCM technology in a lightweight package that overcomes the prior art limitation of weight and overhead and without the necessity of replacing existing SCM systems.

Still another object of the present invention is that the users can have functionalities and features similar to those currently provided by existing SCM technology in a lightweight package that can be updated “on the fly” by user-initiated changes to the business solution.

Still another object of the present invention is that the users can have functionalities and features similar to those currently provided by existing SCM technology in a lightweight package that can be updated “on the fly” without taking the system offline to update for changes in user base, data sources, data destinations or changes in business logic or business solutions.

A further object of the present invention is that the users can have functionalities and features similar to those currently provided by existing SCM technology with minimum coding and recoding, thereby allowing a wide range of users to use and participate in the present invention, including users who are not necessarily skilled in the art.

Still other objects, features and advantages of the present invention will be readily apparent in one skilled in the art from the following description. The drawings and descriptions are to be regarded as illustrative in natures, and are not to be restrictive. What is intended to be protected by Letters Patent is as set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

FIG. 1 and attached Glossary of Terms together form a block diagram of the preferred embodiment Inventory Mitigation System (IMS) in accordance with the present invention.

FIG. 2 is a an example workflow which could be implemented in the IMS shown in FIG. 1 is for the operational activities of Users using the software routine supported by the IMS shown in FIG. 1.

FIG. 3 an example workflow which could be implemented in the IMS shown in FIG. 1 for the operational activities of Administrators using the software routines supported by the IMS shown in FIG. 1.

### DETAILED DESCRIPTION OF THE INVENTION

In the following description of the invention, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

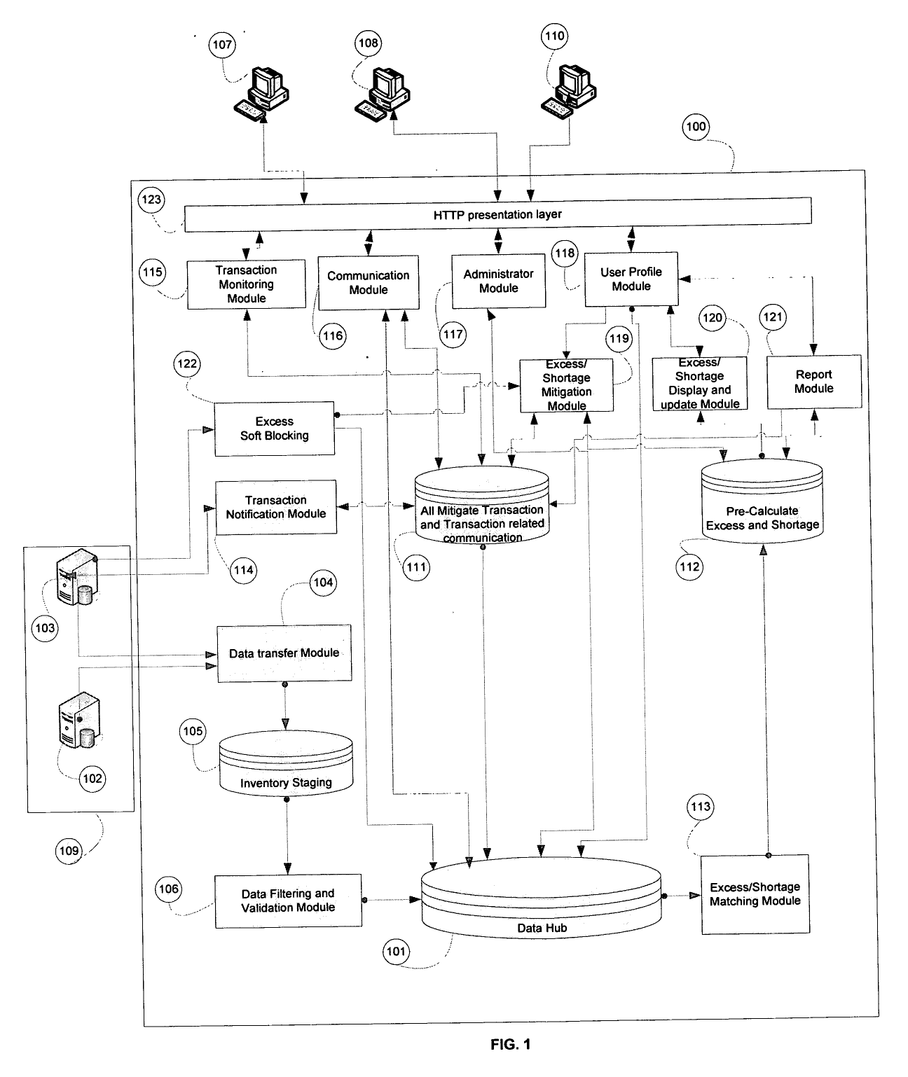

Referring now to FIG. 1 and its accompanying Glossary of Terms, a block diagram of the preferred embodiment IMS system 100 in accordance with the present invention is shown.

The IMS 100 is a client/server web-based product consists of the following:

1. The Information System (IS) department of the business enterprise establishes a host-operated inventory data hub 101 (herein called Hub), consisting of an information management system or multiple software components running as a single system hosted on a computer server or a plurality of computer servers or a distributed computer system having information processing and storage capabilities and electronic communication connection into the Internet or Intranet such as T-1 or T-3 connection. The computer servers or distributed computer system can be physically close together and connected by a local network, or geographically distant and connected by a wide area network, and can comprise any number of possible configurations—mainframes, personal computers, workstations, minicomputers, etc, with the goal of making such a network act as a single computer.

2. Each inventory location (herein called Warehouse) 102 103 within the enterprise is assigned a unique identifier within the Hub. This identifier is linked to all inventory located at the specified Warehouse and linked to all users accessing the Hub from the specified Warehouse. Each Warehouse can comprise of a single Contract Manufacturer (CM) or a divisions or subdivision of a CM or a physical warehouse location of the business enterprise and so forth.

3. Existing inventory data from selected or all of the Warehouses across the enterprise are initially duplicated on the Hub using existing data transfer programs 104 to a holding and staging station 105 prior to transfer into the Hub. At the staging step, each inventory item can be optionally tested for suitability for loading to the Hub 106 (e.g., the IS determines that the Hub will only handle manufacturing parts and would not accept used office equipment), assigned a unique identifier linking it to a Warehouse, and other attributes attached to the inventory part for tracking and processing. Subsequently, the IS can update inventory information from the Warehouses on a scheduled or as-needed basis as determined by the IS.

4. Each user (herein called User) 107 108 accessing the Hub is assigned a unique identifier (log-in ID) and password utilized by the Hub to identify each upon their log in into the Hub. Each User is further identified as linked to a base Warehouse and granted limited electronic access to the Hub to carry out specified approved activities, representative illustrations of which are set out below. Each User is further assigned to an IS-defined community 109 (herein Community) which consists of one or more Warehouses. A Community defines the maximum portion of the Hub to which the specified User has access. For illustrative purpose, a User assigned to a Los Angeles warehouse may be assigned to the Pacific Coast Community, consisting of Warehouses located only in California, Washington, and Oregon.

5. Users which are allowed certain administrative functions such as management of User base, Communities and Sub-Communities and software routines are referred to as Administrators 110. Administrators are granted administrator access to the Hub to carry out specified administrative activities, representative examples of which are set out above. Administrators are assigned to a specified Community which consists of one or more Warehouses.

6. The Hub maintains primary responsibility as a depositary for inventory information and for database manipulation. The Hub operates in a database format in which each inventory item is maintained as one of a plurality of records and assigned a unique identifier for locating, tracking and processing purpose. Each record is formatted to a base template that has a plurality of fields wherein each field is intended to contain a specific type of information about the inventory item. Similarly, the Hub maintains each User record as one of a plurality of records, each formatted to a base template that has a plurality of fields wherein each filed is intended to contain a specific type of information about the User and the approved activities of the User.

7. The Hub maintains software programs and software routine modules 104 105 106 111 through 122 inclusive of a software presentation layer 123 to assist the IS of the enterprise and the Users in managing the inventory, conducting balancing exchanges, and updating dynamically and iteratively the inventory data and user upon each completed balancing exchange and each change in user base. Representative and minimum required software routines include routines to input, control and stage the initial inventory upload 104 105 106, track and update inventory and Users 115 117 118 120, conduct searches for inventory matching User-initiated search parameters 112 113 117, generate reports based on User-defined criteria 115 121, open email, file attachments and chat communications between Users 111 116, link inventory balancing transactions to shipping and handling services or payment services 111 116, execute inventory balancing transactions 111 11 9 and dynamically and iteratively updating inventory data, User data and other Hub data upon each completed balancing exchange, change in user base and change in other Hub data 114 115 117. Software routines employed at the Hub described herein are representative and not meant to be limiting, and other software routines or embodiments of the invention described herein are limited only by human imagination. Representative description of software routines located at the Hub may include the following scenario:
A software routine which allows each Warehouse to upload available inventory to the Hub and allows the Hub to screen all uploaded inventory prior to loading on the Hub for suitability (e.g., no personal property of employees, no office furniture), assign unique identifier to all inventory items, sort items and load items 104 105 106.
A software routine which allows Users to search and view all Excess and Shortage inventory within his assigned Community by part number, location, cost pricing or other User-determined criteria 112 113 120 121.
A software routine which allows Users to determine Excess and Shortage inventory 112 113 117 122. In this example, the User approved to run this routine first defines “Excess” and “Shortage,” i.e., the difference between inventory on hand for a specific part and inventory needed for the next 60 days (or other predetermined or optionally user-specified time period). If the difference is less than a predetermined number (or optionally a user-specified period), the Hub alerts the User that he faces a Shortage and also calculates the amount of Shortage. The Hub also automatically displays for the User any Excess for the specified part within the Community, the location, the cost pricing, and other information regarding Excess available. If the difference is more than a predetermined number (or optionally a user-specified period), the Hub alerts the User that he has an Excess and optionally lists the Excess as available for transfer to other Warehouses for viewing and actions the Users.
A software routine which allows Users to define its own optimal reserve inventory level requiring further user intervention to complete an inventory balancing transaction 122. If the inventory level at the User's warehouse is below the user-defined reserve level, the Hub will alert the Users of the potential shortfall and temporarily block any inventory balancing transaction which would permit the inventory level to fall below the reserve level. The temporary block can be override by the User and is referred to as soft-blocking;
A software routine which allows Users to initiate communication with another User to negotiate an inventory balancing or exchange transaction to fill his Shortage and optionally to complete the transaction, link to shipping and handling details, internal pricing details and other Hub-defined activities 111. Optionally, the software routine can update the transaction-specific information in real time and dynamically and upload the changes to the affected Users without the need for the Users to refresh or reload their Web view page 120.
A software routine which allows Users to list Excess inventory available for trade, list location of the Excess inventory and specify acceptable terms 104 105 106.
A software routine which tracks inputs of inventory, transactions involving existing inventory, removal of inventory from the Hub, and other changes in inventory and changes in other information held in depository at the Hub (such as new users, new Warehouses and other information) and load the changes immediately to the Hub and to all Users in real time and dynamically without the need for Users to refresh or reload their Web view pages 114 115 120.
One or more software routines for administrative purposes, including the management of the User base, the management of Communities and Subcommunities and management of operational software routines within the Hub 117.
One or more software routines for dynamically and iteratively updating Hub data upon each completed exchange, change in User data and other Hub data 114 115 120.
Other software routines may be identified and applied at the Hub to facilitate and support the inventory mitigation and balancing, to enhance the reporting capabilities, to improve viewing ease for Users, or for other corporate needs as identified.

Software routines described herein are intended to be within the scope of the invention and optionally described in more details in further applications in compliance with patent laws and regulations.

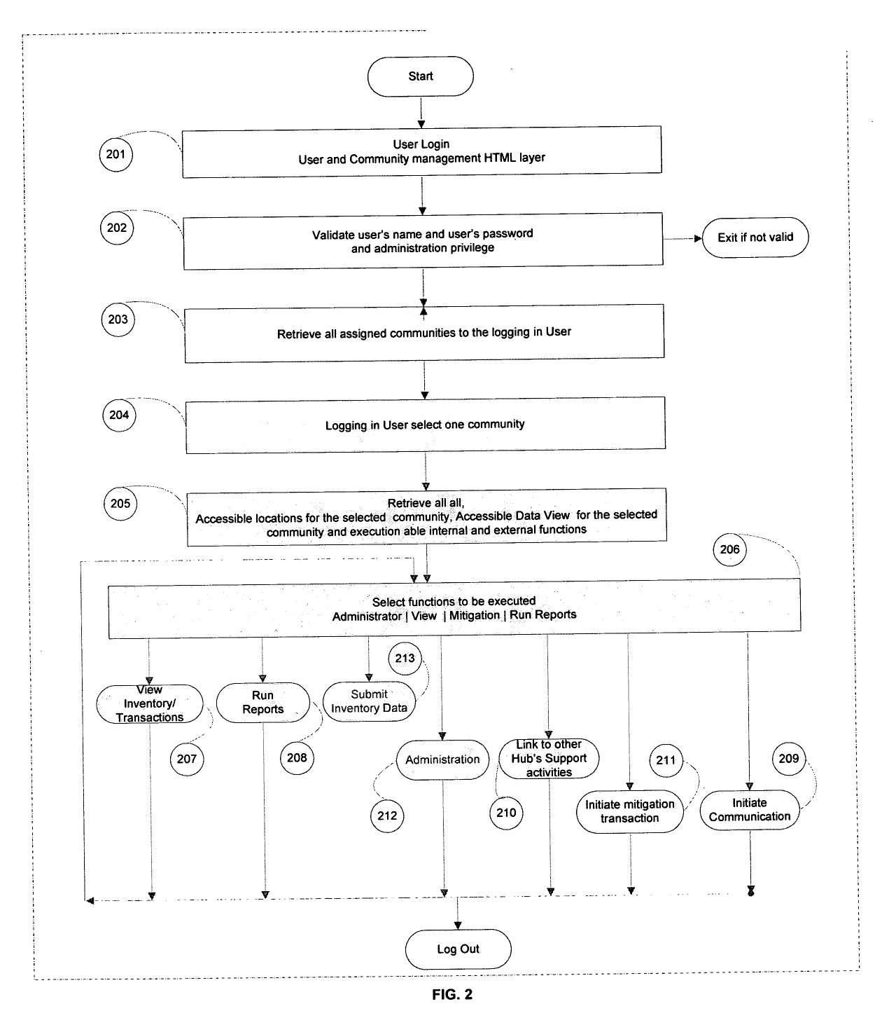

Referring now to FIG. 2, an example workflow which could be implemented in the IMS shown in FIG. 1 is shown for the operational activities of Users using the software routine supported by the IMS shown in FIG. 1.

8. Because each User is uniquely identified, the Hub is able to present a unique log-in page (View page) to each User upon each log-in of the User in the presentation layer 123 (FIG. 1). Similarly, the Hub is able to limit each User to specific approved activities (Approved Activities) based on predetermined criteria. Upon User log-in 201, the Hub validates the User's name and password 202 and retrieves the unique log-in page for the User, including a list of Community(ies) to which the User belongs 203. The User must select one Community (if he belongs to more than one Community) for each log-in session 204. Upon the User's selection of a Community, the Hub then retrieve all accessible locations for the selected Community for the specified User, all accessible data views for the specified User, and all executable internal and external functions for the specified User 205. The User can then select from among the locations, data views and executable internal and external functions available to him 206 through specified administrative software routines 212.

9. Representative examples of Approved Activities for a specified User may include the following scenario:
A User associated with the Los Angeles Warehouse is in charge of sourcing inventory for the local manufacturing plant. After approval from the Hub and assignment to a Warehouse (Los Angeles) and a Community (continental United States), this User is allowed to do the following activities: (i) view all inventory in his assigned Community 207; (ii) run “My Shortage Inventory” reports based on parts and other criteria as determined by the User 208, (iii) run reports of available Excess inventory for exchange based on part numbers, location, cost pricing within his assigned Community 208; (iv) initiate communication with Users in different Warehouses 209 and initiate an inventory exchange transaction as appropriate 211, (v) submit Shortage requests to the Hub 213, (vi) link to all Hub-supported activities to complete the inventory exchange transaction such as shipping and handling, internal cost accounting and invoicing 210; (vii) run reports on User-initiated activities or other Community activities as approved by the Hub 208 and (viii) conduct allowable administrative functions for example customization of his log-in page 212. Because his job involves only Shortage mitigation, this User may not be approved to list Excess inventory in the Hub and may not have managerial privileges to see activities of other Users within the Warehouse or the Community. This User is allowed to set his log-in View page to include any or all or a combination of his Approved Activities.
A User associated with the San Francisco Warehouse is in charge of maximizing return for his Warehouse from Excess inventory. After approval from the Hub and assignment to a Warehouse (San Francisco) and a Community (continental United States), this User is allowed to do the following activities: (i) view all inventory in his assigned Community 207; (ii) run “My Excess Inventory” reports based on parts and other criteria as determined by the User 208, (iii) run reports of needed Shortage inventory listed by other Warehouses based on part numbers, location, cost pricing within his assigned Community 208; (iv) initiate communication with Users in different Warehouses to offer to exchange inventory 209 and initiate an inventory exchange transaction as appropriate 211, (v) submit Excess inventory into the Hub 213; (vi) link to all Hub-supported activities to complete the inventory exchange transaction such as shipping and handling, internal cost accounting and invoicing 210; (vii) run reports on User-initiated activities or other Community activities as approved by the Hub 208 and (viii) conduct allowable administrative functions for example customization of his log-in page 212. Because his job involves only Excess mitigation, this User may not be approved to list Shortage inventory needed for his Warehouse in the Hub and may not have managerial privileges to see activities of other Users within the Warehouse or the Community. This User is allowed to set his log-in View page to include any or all or a combination of his Approved Activities.
A User associated with the Oakland Warehouse is the manufacturing manager. After approval from the Hub and assignment to a Warehouse (Oakland) and a Community (Enterprise Worldwide), this User is allowed to do the following activities: (i) view all inventory in his assigned Community 207; (ii) run all Excess and Shortage reports for his Warehouse 208; (iii) initiate communication 209 and initiate Excess and Shortage exchange transactions 211, (iv) view all Excess and Shortage exchange transaction within his Warehouse (and optionally within his Community) 207; (v) submit Excess inventory and Shortage requests to the Hub 213, (vi) link to all Hub-supported activities to complete the inventory exchange transaction such as shipping and handling, internal cost accounting and invoicing 210; (vii) run reports on User-initiated activities or other Community activities as approved by the Hub 208 and (viii) conduct allowable administrative functions for example viewing all Users activities under his direct command or set allowable activities for all Users under his direct command 212. This User is allowed to set his log-in View page to include any or all or a combination of his Approved Activities.

Approved Activities described herein are intended to be within the scope of the invention and optionally described in more details in further applications in compliance with patent laws and regulations.

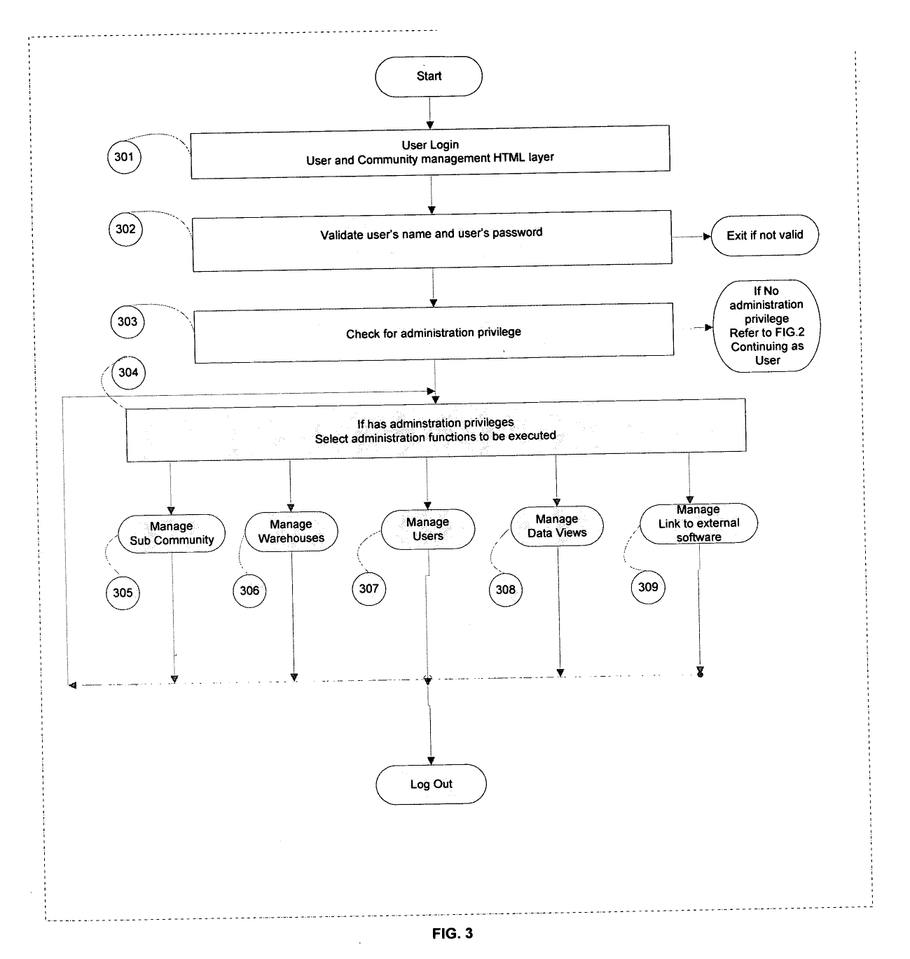

Referring now to FIG. 3, an example workflow which could be implemented in the IMS shown in FIG. 1 is shown for the operational activities of the Administrators of the IMS shown in FIG. 1.

10. Because each Administrator is uniquely identified, the Hub is able to present a unique log-in page (View page) to each User upon each log-in of the Administrator in the presentation layer 123 (FIG. 1). Similarly, the Hub is able to limit each Administrator to only his Approved Activities based on predetermined criteria. Upon Administrator log-in 301, the Hub validates the Administrator's name and password 302 and retrieves the unique log-in page for the Administrator, including a list of Community(ies) to which the Administrator belongs 303. The Administrator must select one Community (if he belongs to more than one Community) for each log-in session 304 and optionally the Administrator must select whether to continue the log-in session as an Administrator or a User. If the Administrator selects to continue as a User, then the Hub would continue the log-in session in the manner as described in FIG. 2. If the Administrator selects to continue the log-in session as an Administrator, then upon the Administrator selection of a Community, the Hub then retrieve all assigned Users belonging to the selected Community, all accessible locations for the selected Community for the specified Administrator, all accessible data views for the specified Administrator, and all executable internal and external functions for the specified Administrator 304. The Administrator can then select from among the locations, data views and executable internal and external functions available to him 304, representative examples of which may include the management of communities and subcommunities 305, management of warehouses 306, management of Users 307, management of data views for Users 308, management of software routines and links to external software routines 309, and management of software routines 310.

The foregoing description of the IMS and the exemplary embodiment of the invention have been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto. It will be appreciated by one skilled in the art that this system can be configured utilizing modern application server, XML or .NET technology provided by software vendors like IBM, Microsoft, Oracle etc. without departing from the scope and spirit of the present invention.

What is claimed is:

1. A computer-implemented method for dynamically and iteratively tracking, matching and exchanging inventory excess and shortage, comprising the steps of:
specifying an inventory hub consisting of an information management system and storage means;
specifying a plurality of Warehouse inventory data sources containing inventory data;
specifying a plurality of users of inventory data for inventory viewing and balancing purposes;
specifying at least one administrator for management of data and software routines;
constructing a plurality of software routines with coupling means to the inventory data source and users and administrator and containing at least one software routine to do data transfer, filtering and validation, one software routine to set up, register and manager users, administrators and Warehouses accessing the inventory hub, one software routine for extract, transfer and load inventory data, one software routine for search and match inventory for balancing transaction, one software routine for search result presentation and data presentation and display, one software routine for transaction execution and tracking, one software routine for updating change to the inventory data, one software routine for communication and one software routine for administrative functions;
extracting, transferring and loading inventory data based on user-determined criteria to said inventory hub;
searching and matching inventory excess and shortage according to user-initiated rules;
presenting search results to users according to user-initiated commands;
executing and tracking inventory balancing transaction according to user-initiated commands;
executing and tracking changes to user base and inventory data according to administrator-initiated commands;
updating changes to said inventory hub and transmitting changes to initial inventory data sources automatically and iteratively by software without human intervention;

2. The computer implemented method of claim 1, where the software routine to extract, transfer and load inventory data include at least one routine to update inventory information from the inventory data sources on a schedule or optionally as triggered by user-defined criteria;

3. The computer implemented method of claim 1, where each user and each administrator is assigned to a base of a Warehouse consisting of one inventory data source and further assigned to an administrator-defined Community consisting of one or more Warehouses;

4. The computer implemented method of claim 1, where the software routine to search and match inventory excess and shortage include at least one routine to allow users, administrators and Warehouses to define its own excess ad shortage criteria;

5. The computer implemented method of claim 1, where the software routine to search and match inventory excess and shortage include at least one routine to allow users, administrators and Warehouses to define its own optimal reserve inventory level requiring further user intervention to complete an inventory balancing transaction, i.e., soft blocking the inventory balancing transaction if inventory level at a specified Warehouse is at or below the reserve level;

6. The computer-implemented method of claim 1, where the software routine to present and display data include at least one routine to display a unique log-in page and display page for each user and administrator based on criteria set within the user profile and based on user-specified criteria;

7. The computer-implemented method of claim 1, where the software routine to execute and track inventory balancing transactions contains at least one routine to transmit and update all changes to the user base and inventory data source dynamically, iteratively and without further human intervention;

8. The computer-implemented method of claim 1, where the software routine for communication contains at least one routine to allow communication by means of electronic mail with attachments, which attachments can be files, executable software programs, pictures, audio clips, video clips or any combination thereof;

9. The computer-implemented method of claim 1, where the software routine for communication contains at least one routine to allow instant user to user communication by means of electronic chat or electronic instant messaging;

10. The computer-implemented method of claim 1, where the software routine for communication contains at least one routine to track and sort communications by transaction identification number or part identification number or user identification number or administrator identification number or Warehouse identification number or date or by sequence.
